(19) United States
(12) Patent Application Publication
(10) Pub. No.: US 2002/0073428 A1
(43) Pub. Date: Jun. 13, 2002

(54) Downloading and transfer of audio or video data from video broadcasts

(76) Inventors: Leonid Gurevich, Thornhill (CA); Sergei Kazantsev, Maple (CA); Lev Olkha, North York (CA); Eduard Zaslavsky, Maple (CA)

Correspondence Address: John P. Ward, Blakely, Sokoloff, Taylor & Zafman LLP, Seventh Floor, 12400 Wilshire Boulevard, Los Angeles, CA, 90025-1030, US

(21) Appl. No.: 09/733,824

(22) Filed: Dec. 8, 2000

Related U.S. Application Data
(60) Provisional application No. 60/239,490, filed on Oct. 11, 2000.

(51) Int. Cl. G06F 3/00; H04N 5/445; G06F 13/00; H04N 7/173

(52) U.S. Cl. 725/86; 725/87; 725/101; 725/100

(57) ABSTRACT

A method for purchasing, downloading, and transferring audio and/or video data files through video broadcasts is disclosed. The user signals the set-top box of his video viewing system that he is interested in downloading the audio/video data file being offered. The box records the time, the channel being viewed, and, where applicable, the user ID. The box then sends this information to the controlling server when it next reports in. The server transmits the requested data, either over the Internet or by broadcasting it back to the set-top box, where it can be downloaded to a desired format.

### FIELD OF THE INVENTION

The present invention relates generally to the field of electronic commerce (E-commerce). More specifically, the present invention is directed to a method and an apparatus for executing the E-commerce of multimedia through television.

### BACKGROUND

This application claims priority under 35 U.S.C. §119(e) from provisional patent application filed under 37 C.F.R. §1.53(d), entitled “DOVWNLOADING AND TRANSFER OF AUDIO AND/OR VIDEO”, filed on Sep. 6, 2000, Provisional Ser. No. 60/230,490.

In many cases, set-top boxes have the ability to do T-commerce (electronic commerce, or E-commerce, executed from television). However, T-commerce is typically limited to two methods. The user can order physical merchandise, which is then shipped by regular shipping services such as Fed Ex, UPS, US Postal Service, etc. Alternatively, the user can order video transmissions such as video on demand, which requires the viewer to use (i.e., view or listen to) the merchandise at the point of delivery, in this case a set-top box and its associated TV system.

However, in some situations, a viewer may want to order an audio or video file or service through the TV set-top box, but be able to watch it or listen to it apart from the set-top box on which it was received. At the same time, the viewer may not wish to wait for the shipment of a physical medium, such as a CD or DVD.

What are clearly needed are a method and a system that allows a user in such situations to interactively order, download, and then transfer items of interest to devices or media other than the receiving set-top box.

### SUMMARY OF THE INVENTION

In one embodiment of the present invention, a method for purchasing, downloading, or transferring audio and/or video data files through video broadcasts is disclosed. The user signals the set-top box of his video viewing system that he is interested in downloading the audio/video data file being offered. The box records the time, the channel being viewed, and, where applicable, the user ID. The box then sends this information to the controlling server when it next reports in. The server transmits the requested data, either over the Internet or by broadcasting it back to the set-top box, where it can be downloaded to a desired format

### BRIEF DESCRIPTION OF THE DRAWINGS

The present invention is illustrated by way of example in the following drawings in which like references indicate similar elements. The following drawings disclose various embodiments of the present invention for purposes of illustration only and are not intended to limit the scope of the invention.

FIG. 1 is an illustration of a content delivery system.

FIG. 2 is a flowchart describing steps performed according to one embodiment

FIG. 3 is a flowchart describing steps according to one embodiment that allows choosing from multiple methods of delivery.

FIG. 4 is an illustration of an embodiment of the view screen visible to the user when a cursor is involved.

FIG. 5 is a diagram of an alternative embodiment of a content receiving system.

### DETAILED DESCRIPTION

A system is described that allows viewers, through a single button-click, to order audio or video data associated with a TV program. In one embodiment, when audio or video data, such as movies and songs, are offered during a television show, the viewer presses a button on the remote control for the set-top box. The set-top box then records the time, date, and channel being watched. At the next point in which the set-top box calls to check in with its governing server, it appends the data to the message being sent. A database matches the time, date, and channel with its available offers. The audio or video data material would then be delivered via the Internet, directly to the set-top box in an easily transferable form, or by regular mail.

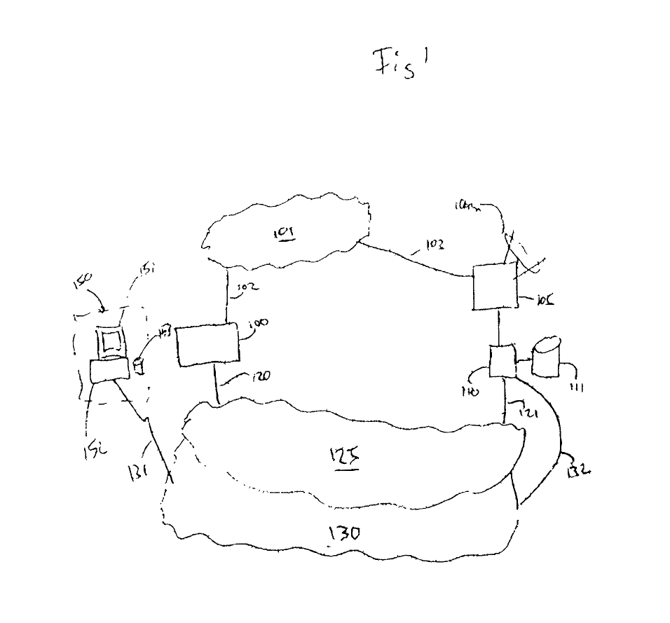

FIG. 1 shows an overall view of the system according to this embodiment. Set-top box 100, for example, is connected via broadcast system 101, local connector 102, and uplink 103 to head-end 105. Broadcast system 101 may consist, for example, of a satellite system, in which case connector 102 would consist of a satellite dish, etc. In other cases broadcast system 101 may be a terrestrial broadcast system, and local connector 102 would be an antenna. Alternatively, broadcast system 101 may be a regular cable system with cable distribution, and local connector 102 would then be a hook-up for the house. Additionally, broadcast system 101 may be a combined system of, for example, satellite plus local TV via antenna, or cable system plus satellite, or cable system plus aerial, or any combination thereof. Both analog and digital broadcasts may be used.

A set-top box 100 is connected, directly or otherwise, to a viewing system such as a television, projection screen, etc. (not shown), as is customary in the art. Typically, a remote control, either a multifunction model or one for the set-top box only, can be used to operate the novel functions of this embodiment.

Many existing set-top boxes include a back-link 120. Typically this back-link dials through a phone system 125. In some cases, instead of connecting through the phone network, the back-link creates an Internet connection through the Internet 130. The back-link also may use a dedicated phone connection to a server 110 with mass storage 111. Alternatively, a back-link is made using the broadcast system, by using such techniques as satellite uplink or cable modems. In other cases, cell phone or pager systems may be used for back-links.

These links perform many functions Often they are used to renew keys for programming setup and identify whether the box is installed in the correct location as licensed for use. In a satellite system, these links decide which channels can be viewed and which not in accordance with Federal Communications Commission (FCC) rules.

Typically, such boxes connect once a day, or once every few days, to a toll-free or local number for transmitting and/or receiving a few short blocks of data that are then managed by server 110 and use database 111. Obviously, there may be more than a single server, and there may be more than a single database, but for purposes of simplicity in the current embodiment, only one of each is shown here.

The server is also connected to head-end 105. This connection allows broadcasting of certain commands back over the broadcast system 101, such as requesting a dial-up, over the broadcast channel to set-top box 100.

The user of set-top box 100 may, in many instances, also own or have access to a personal computer (PC) 150. This PC generally consists of a monitor or display 151, and a central processing unit (CPU) box 152 (main unit). The CPU box holds a mass storage unit 153 that contains software, data, and the like. PC 150 typically has a link 131 available to Internet 130, in some cases via phone line, in others via digital subscriber line (DSL) or cable modem or any other kind of connection that is well known in current art. Often, the PC may be actually available at a workplace, rather than at the home.

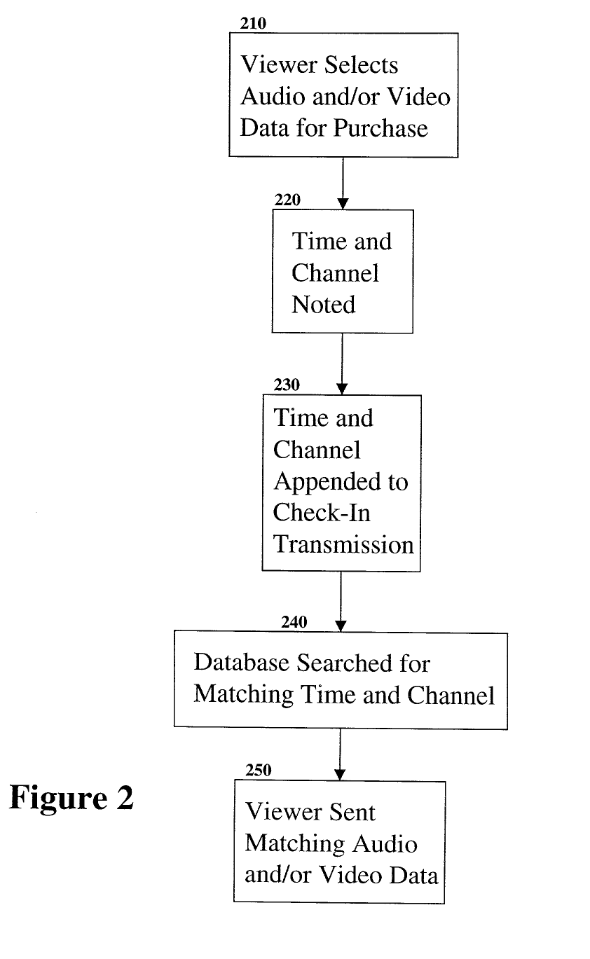

A simplified version of the method to be used is illustrated in FIG. 2. While viewing a program, whenever a user sees an item of interest, the user can push a previously specified button on the remote control 210. Typically remote controls have several special buttons that are not always used. The button would cause the set-top box to record the time and the channel being viewed 220. Additionally, when multiple user IDs are programmed into a set-top box, the box can then record currently selected user ID.

During the next regularly scheduled call-in by the set-top box (the next time the set-top box connects to server 110), in addition to its regular communications, the set-top box now adds some additional blocks of data to the transmission 230. These blocks of data would inform the server that the user had made a selection. The server would search the database to see what audio or video data files are associated with that time and channel 240. If the box only serves a single user, the server will send the requested data by the requested delivery method 250, such as via the Internet 130 to the user's computer or broadcast 101 to the user's set-top box. If the set-top box has multiple users programmed into it, the server will use the delivery method specified by the recorded user ID. In some cases, the call can also be initiated immediately, either at the users request, or on demand from the system operator, through pre-programming.

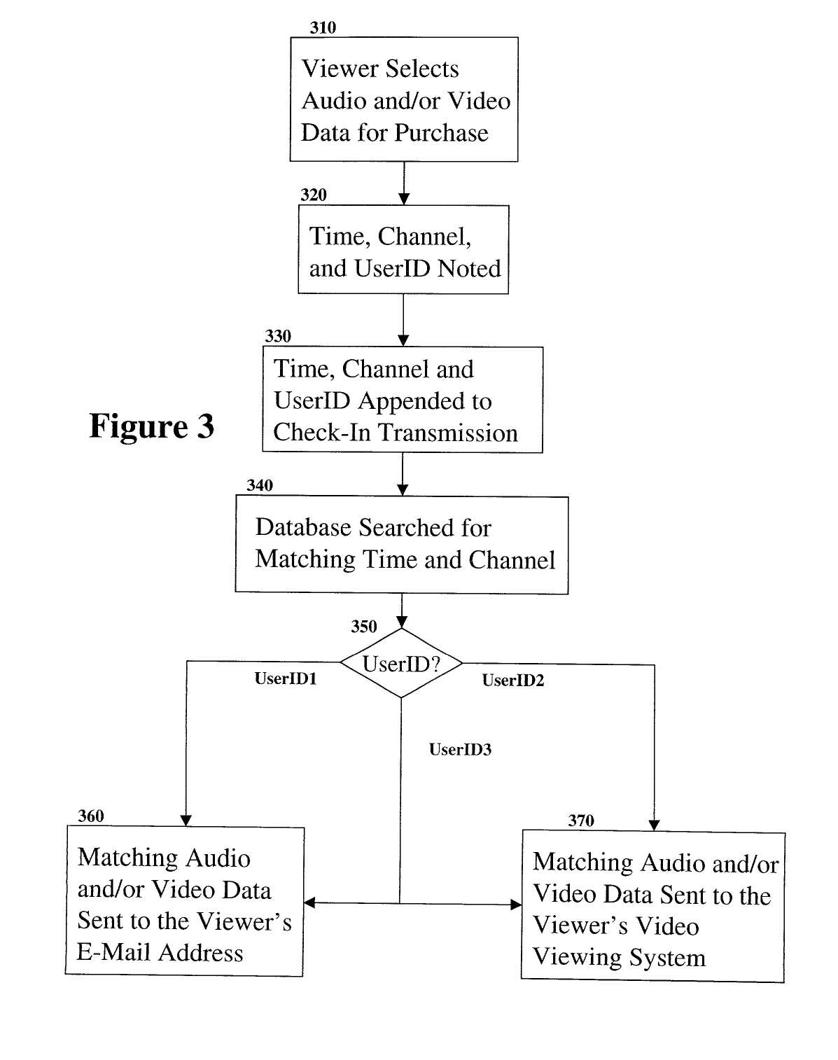

A single user could use different ID numbers to specify different methods of delivery, as illustrated in FIG. 3. The viewer would select the audio or video data files that he wishes to purchase 310. The set-top box would note the time, channel, and UserID 320, and then append them to the next check-in transmission with the server 330. The server would then search the database to see which audio or video data files are associated with that time and channel 340. Then the UserID would be checked to see which method of transmission is preferred 350. For example, UserID1 would tell the server to send the data files over the Internet 360, while UserID2 would tell the server to send the data files over the broadcast system to the set-top box 370. UserID3 would tell the server to send copies to both an e-mail address 360 and a set-top box 370.

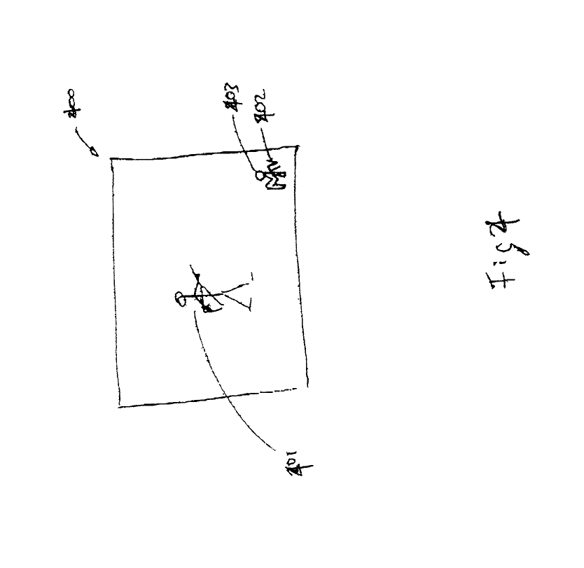

FIG. 4 shows a scene, typically a music video, from, for example, MTV™ on screen 400. Guitarist 401 is playing a song. By either setting the cursor on “hot” area 403 and then clicking it or, in cases where no cursor control is available, hitting the “Activate” button on the remote control for the set-top box 100, the user can download a file, such as a Moving Picture Experts Group-1 Audio Layer-3 (MP3) audio file, into the set-top box 100 or have it delivered to the user's computer through the Internet.

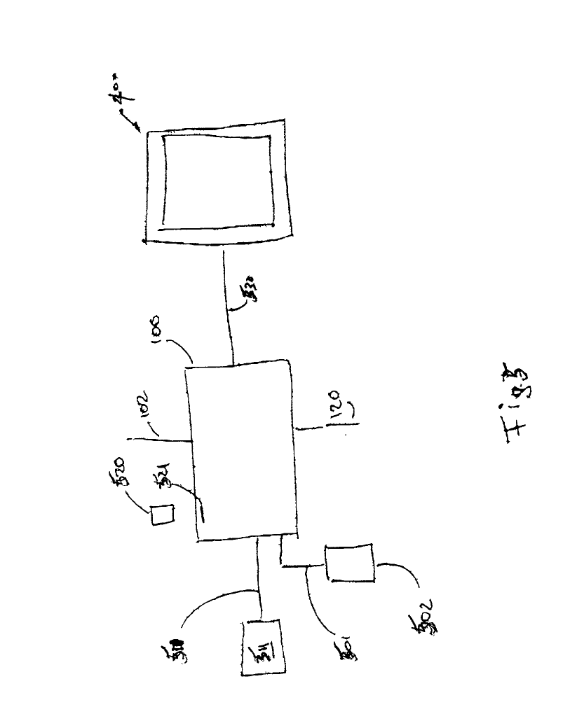

FIG. 5 shows a close-up view of set-top box 100 with TV 400 connected. The connection 530 between the two devices may be of any kind well known in the art, such as, but not limited to, analog, digital, S-Video, “1394”, universal serial bus (USB), etc. Also the TV system may be of any type known in the art, including but not limited to a regular TV, projection, back projection, flat screen, and its transmission type may be analog, digital, high definition television (HDTV), or any other transmission type known in the art.

In addition to its connection to a TV 400, set-top box 100 may have a connection to a MP3 player 502, compact disc (CD) writer 511, or digital versatile disc (DVD) writer 511. One embodiment would be set-top box 100 having a connection 501 to an MP3 player 502. The connection may be to any audio or video file player that can download files from a port. Connection 501 could be a serial port, a USB port, or any other port of that nature. Thus a user may download one or several selected audio or video files from set-top box 100. These files may have been initially downloaded into internal storage in set-top box 100 or, where storage is not available in the box, the file may be downloaded and stored directly on the player.

Additionally, a CD programmable read-only memory (CD PROM) or a DVD random access memory (DVD RAM) 511 may be used to send files such as MP3 or other audio or video format onto CDs or DVDs. These memory devices would allow the user to store larger amounts of data and use the data in conjunction with existing systems, such as a DVD player or a CD player in a car.

In this embodiment, the CD PROM or CD writer has a different connection 510, but in fact it may also be a serial, parallel, USB, or any other type of connection that has sufficient bandwidth to transmit the data. In some cases, the connection may be a “1394” connection, to allow downloading and permanent storage of videos. Video downloading is preferably done via a fast connection such as “1394”, but could also be done over a USB connection.

As yet another embodiment, as an alternative or in combination, a slot 521 is provided to allow the user to insert memory media 520. This memory media would include a Sony Memory Stick®, flash file, flash card, or any other type of memory modules known in the art that can be used to store and later play back audio and/or video files in players such as MP3 players or video players. In such cases, the media can be stored, uploaded from the set-top box, and then inserted into a player on demand, at any time and place desired by the user.

In some cases, all or part of the messages may be encrypted or scrambled, using techniques well known in the art, such as public key. A smart card (not shown) may be used to securely store a key. In some other cases, payment may be done with a credit or debit card, including smartcards. Such messages would be sent encrypted, so no server transaction is required to clear payments.

The method and apparatus disclosed herein may be integrated into advanced Internet- or network-based knowledge systems as related to information retrieval, information extraction, and question and answer systems.

The method described above can be stored in the memory of a computer system (e.g., set top box, video recorders, etc.) as a set of instructions to be executed. In addition, the instructions to perform the method described above could alternatively be stored on other forms of machine-readable media, including magnetic and optical disks. For example, the method of the present invention could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the methods as discussed above, could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method, comprising:
receiving an order for audio or video data via user selection from a video broadcast through a video viewing system;
transmitting the order from the video viewing system to a server and data storage device; and
transmitting the requested audio or video data to the user in a portable electronic form.

2. The method of claim 1, wherein the order for data is stored by the video viewing system for transmission to a head-end by noting a time and channel viewed when signaled by the user.

3. The method of claim 2, wherein a user identification number is recorded along with the time and channel viewed.

4. The method of claim 2, wherein an encrypted credit or debit card number is recorded along with the time and channel viewed.

5. The method of claim 1, wherein the order for data is appended to a communication between the video viewing system and a server regulating the broadcast received via a communications medium.

6. The method of claim 1, further including: receiving from the user preprogrammed instructions detailing a method of transmission

7. The method of claim 3, wherein the user identification number determines a method of transmission.

8. A system comprising:
a video viewing system for displaying a video program and receiving orders for audio or video data from a viewer;
a broadcast system over which to send the video programs;
a server for receiving and processing orders for audio or video data
a communications medium between the video viewing system and the server; and
a link between the server and the viewer for delivery of the audio or video data in a portable electronic form.

9. The system of claim 8, wherein the television viewing system comprises:
a set-top box; and
a video viewing media.

10. The system of claim 8, wherein the video viewing system includes a cursor control which allows a user to signal selection by placing the cursor in a specific area, or “hot” area, of the viewing medium's screen.

11. The system of claim 8, wherein the video viewing system includes a remote control with an “activate” button, which signals selection of an audio or video data program.

12. The system of claim 8, wherein the order for data is appended to the normal regular communications between the video viewing system and a server regulating the broadcast received via a communications medium.

13. The system of claim 8, wherein more than one server and mass data storage unit service the video viewing system.

14. The system of claim 8, wherein the requested data is transmitted via a broadcast system to the user's video viewing system.

15. The system of claim 14, wherein the video viewing system includes an audio or video file player that can download the audio or video data from a port.

16. The system of claim 14, wherein the video viewing system includes a removable memory media that stores the audio or video data.

17. A machine-readable storage medium tangibly embodying a sequence of instructions executable by the machine to perform a method comprising:
receiving an order for audio or video data via user selection from a video broadcast through a video viewing system;
transmitting the order from the video viewing system to a server and data storage device; and
transmitting the requested audio or video data to the user in a portable electronic form.

18. The machine-readable storage medium of claim 17, wherein the order for data is stored by the video viewing system for transmission to a head-end by noting the time and channel viewed when signaled by the user.

19. The machine-readable storage medium of claim 18, wherein a user identification number is recorded along with a time and channel viewed.

20. The machine-readable storage medium of claim 17, wherein the order for data is appended to the normal regular communications between the video viewing system and a server regulating the broadcast received via a communications medium.

21. The machine-readable storage medium of claim 17, wherein the user preprograms into the video viewing system a method of transmission.
